(19) United States
(12) Patent Application Publication
(10) Pub. No.: US 2007/0246936 A1
(43) Pub. Date: Oct. 25, 2007

(54) Connection device for a pipe

(75) Inventor: Thomas Jeltsch, Domat/Ems (CH)

Correspondence Address: MORGAN LEWIS & BOCKIUS LLP, 1111 PENNSYLVANIA AVENUE NW, WASHINGTON, DC, 20004, US

(73) Assignee: Ems-Chemie AG

(21) Appl. No.: 11/783,747

(22) Filed: Apr. 11, 2007

(30) Foreign Application Priority Data
Apr. 12, 2006 (EP) 06007696.5

(51) Int. Cl. F16L 37/00

(52) U.S. Cl. 285/319; 285/305

(57) ABSTRACT

The invention relates to a connection device for a pipe (40) with an annular outer groove (41), which device has a housing (10) in which the pipe (40) may be inserted and locked therein by means of a locking element (30), wherein the locking element (30) engages in an annular inner groove (13) of the housing (10) and in the annular outer groove (41) of the pipe (40), and can be pulled out of the housing through an opening (14) in the housing (10) in a direction tangential to the annular grooves (13, 41), and wherein the locking element (30) is pre-mountable in the inner groove (13) of the housing (10), enables the pipe (40) to be inserted in the housing (10) in this position, with elastic deformation, and in doing so to engage in the outer groove (41) of the pipe (40), characterised in that the locking element, in this position, is arranged and secured fixedly in the housing by bearing against an edge and by enclosing an edge.

### TECHNICAL FIELD

This invention relates to a connection device for a pipe with an annular outer groove which has a housing into which the pipe can be inserted and can be locked by means of a locking element, wherein the locking element engages in an annular inner groove of the housing and in the annular outer groove of the pipe and can be pulled out of the housing through an opening in the housing in a direction tangential to the annular grooves, and wherein the locking element can be pre-mounted in the inner groove of the housing, enables the pipe to be inserted in the housing in this position, with elastic deflection, and in doing so engages in the annular groove of the pipe.

### STATE OF THE ART

Connection devices of the type mentioned are disclosed, for example, in DD 252 647 A5, DE 29 43 571 C2, DE 91 06 278.0 U1 and DE 295 18 192 U1. In the designs of prior art the pipe must be inserted in the housing before the locking element can be inserted in the housing. During the production of the connection the locking element therefore forms a separate part which must be handled separately.

DE 29 08 337 C2, DE 31 04 518 C2, EP 0 509 970 A1, DE 299 80 147 U1 and DE 20 2004 013 983 U1 disclose connection devices for corrugated pipes in which a locking element to be handled separately during assembly is also provided.

In the connection devices of DE 29 08 337 C2, DE 299 80 147 U1 and DE 20 2004 013 983 U1 the locking element is u-shaped, is inserted in the housing from the side and is pushed onto the corrugated pipe in the manner of a cramp. Since the locking element only bears against the housing and corrugated pipe locally, stresses concentrated on the bearing points are generated under tension, which does not render the connection devices particularly load bearing.

In the devices according to DE 31 04 518 C2 and EP 0 509 970 A1 the locking element surrounds the corrugated pipe in the manner of a clip, so that in principle there is a more favourable transmission of forces here. However, in the device according to DE 31 04 518 C2 the locking element surrounds not only the corrugated pipe but also the housing, from the outside, thereby necessitating an additional outer closure for the locking element.

In the device according to EP 0 509 970 A1 the locking element only surrounds the corrugated pipe and is inserted together with it into the housing. The locking element is then locked in the housing by means of stop arms on the locking element, which engage in through recesses in the housing wall. The stop arms and the housing recesses are relatively narrow in the peripheral direction, so that here too a rather unfavourable concentration of stresses is generated under tensile load.

In the connection device for a corrugated pipe according to EP 0 634 699 B1 the locking element is pre-mountable and does not therefore form a separate part during assembly. The corrugated pipe can easily be inserted in the housing. The locking element also surrounds the corrugated pipe essentially on all sides. Relative to the housing, however, it is only locked by stop arms engaging in local recesses of the housing, as in EP 0 509 970 A1, so that here too unfavourable stress concentrations are generated under tensile load.

WO 2006/007744 shows connection devices for corrugated pipes with a housing, a locking element as a separate part being totally dispensed with. For this purpose the housing itself is provided with stop arms distributed around its circumference. Because of the distribution of the stop around the circumference the device is, in principle, better suited for higher breakout forces, although relatively large gaps are provided between the stop arms for the passage of retaining stays. However, because the stop arms are formed directly on the housing, their engagement in an annular groove of an inserted corrugated pipe can no longer easily be eliminated. As a possibility of loosening the engagement it is proposed to form lugs on the outside of the stop arms. To eliminate the blocking action of the stop arms, however, a special expanding tool must bear against all the lugs simultaneously.

A connection device of the type already mentioned is disclosed by U.S. Pat. No. 6,179,347 B1. In the device of prior art the locking element is not secured, so that it moves in the groove and, in the most unfavourable case, can even be rotated completely out of the housing, particularly if the pipe inserted in it is rotated and the locking element also rotated by friction. The locking element may sometimes also be gradually moved out of the housing under the influence of vibrations, which may be the case particularly in a pipe installation on an engine. Although a secured locking element is also described as the state of the art in U.S. Pat. No. 6,179,347 B1, this element cannot be pre-assembled and is secured by a fixed assembly in the form of a screw connection which must be assembled and dismantled whenever the connection device is produced or removed respectively, at considerable expense. The locking screw designed as a special part in the form of a cap screw projects outwards from the housing and, like the locking element, represents a separate part which must be handled separately.

### REPRESENTATION OF THE INVENTION

The object of the invention is to indicate a connection device of the type already mentioned for a pipe with an annular outer groove which is protected against accidental loosening, without additional assembly cost, but can easily be detached if necessary.

This object is achieved by a connection device according to claim 1. The connection device according to the invention therefore has a housing into which the pipe can be inserted and can be locked in it by means of a locking element. For this purpose the locking element engages in an annular inner groove of the housing and in the annular outer groove of the pipe. Because an opening is provided in the housing it can be pulled out of the housing in a direction tangential to the annular grooves. The locking element is pre-mountable in the inner groove of the housing and in this position enables the pipe to be inserted in the housing with elastic deflection, engaging in the outer groove of the pipe. In this pre-assembled position the locking element is also arranged and secured by stopping on one edge and by surrounding an edge in the housing so that it is torsionally resistant.

The pipe may be any pipe, a pipe socket of a tank or a tubular section of a pipe connector provided with at least one outer annular groove. The pipe could, in particular, be a corrugated pipe which as such already has annular grooves due to the corrugations.

Preferred embodiments of the invention are characterised in the dependent claims.

### BRIEF EXPLANATION OF THE FIGURES

The invention will be explained in further detail in the following on the basis of exemplary embodiments with reference to the drawing, in which:

FIG. 1 shows an exploded view of a connection device according to the invention;

FIG. 2 shows, in a partially sectional representation, the housing of the connection device of FIG. 1, with a locking element pre-mounted and fixedly arranged and secured therein, as well as a seal pre-mounted therein;

FIG. 3 shows, in a partially sectional representation, the connection device with pipe connected;

FIG. 4 shows a first alternative embodiment of a locking element;

FIG. 5 shows a second alternative embodiment of a locking element in a partially sectional view;

FIG. 6 shows a third alternative embodiment of a shutoff element;

FIG. 7 shows diagrammatically in a section the nature of the locking of the locking element in FIG. 6 with a corrugated pipe;

FIG. 8 shows a fourth alternative embodiment of a locking element;

FIG. 9 shows a further embodiment of a connection device in a partially sectional representation, a version with a locking element that can be removed in the anticlockwise direction in a), and a version with a locking element that can be removed in the clockwise direction in b);

FIG. 10 shows in a), in a cross-section, the housing of a connection device with a locking element fixedly arranged and secured therein, and in b), diagrammatically in view X, the nature of the loosening of the locking by torsion;

FIG. 11 shows the embodiment shown in FIG. 10 a), but here the locking element projects from the housing;

FIG. 12 shows, in a partially sectional representation, the housing and locking element shown in FIG. 10 a), the end of the locking element being provided with an insertion opening for a tool, also shown;

FIG. 13 shows in a), in a cross-section, the housing of an embodiment of a connection device with a locking element fixedly arranged and secured therein, and in b), diagrammatically in view X, the nature of the loosening of the locking by lateral outward bending;

FIG. 14 shows an embodiment according to that shown in FIG. 13, but with alternatively loosened protection to prevent the locking element from rotating in the housing;

FIG. 15 shows an embodiment according to FIG. 14 a), but with an additional auxiliary device for moving the locking element out of the housing; and

FIG. 16 shows in a) and b), perspective representations of a meander-shaped locking element with stop nose and insertion opening for a tool.

### METHODS OF IMPLEMENTING THE INVENTION

In the individual figures functionally corresponding parts are provided with the same reference symbols. If similar types of parts occur several times, only one of them will be thus designated.

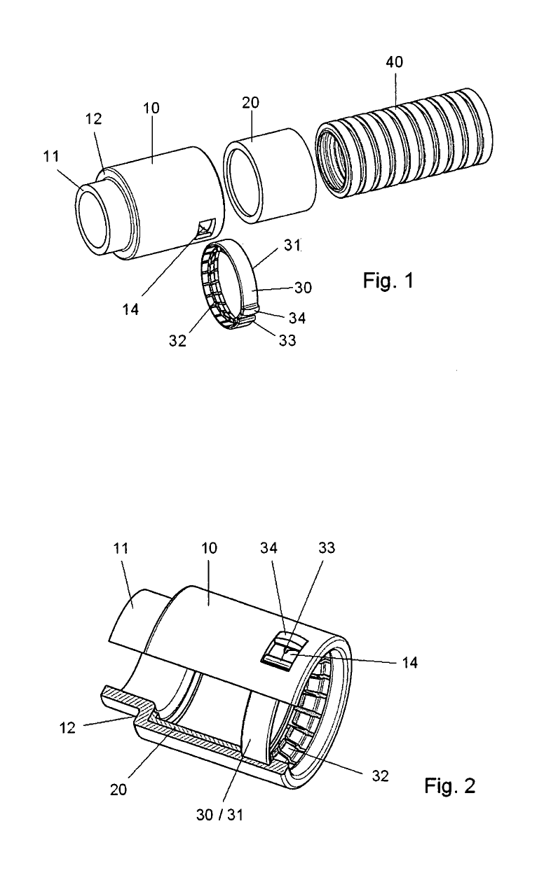

The connection device shown in FIG. 1 comprises a sleeve-shaped housing 10, a seal 20, also sleeve-shaped, and a locking element 30, and serves to connect a pipe, one end section of which is shown and denoted by 40.

The housing has a connection end 11, which is shown in FIG. 1 as a housing section reduced in diameter, but in principle it could be of any other design suitable for the connection of pipes, hoses or the like. Because of connection end 11 reduced in diameter a shoulder 12 is produced in the housing interior, which shoulder serves as a stop for seal 20 mentioned and, if necessary, for pipe 40. A corresponding stop is also advantageously provided when connection end 11 of the housing is to be designed in a manner other than that shown. Housing 10 is also provided with a annular inner groove 13 which has an outlet to the outside through an opening 14.

Sleeve-shaped seal 20 consists of a soft elastic material suitable for sealing purposes and could also be provided with sealing lips or the like. For applications in which tightness of the connection is not important, the seal may also be omitted.

The locking element 30 forms an open ring, but is so flexible that it can be bent into an elongated shape. On a strip-shaped base element 31 it has a multiplicity of stop arms 32 projecting inwards at an oblique angle. The front 33 and rear end 34 of locking element 30 is provided with a thickened section.

Pipe 40 is a corrugated pipe and therefore has alternately corrugation valleys 41 and corrugation peaks 42. Viewed from the outside corrugation valleys 41 in corrugated pipe 40 form annularly circulating outer grooves.

Seal 20 and locking element 30 may be pre-mounted in housing 10. For this purpose seal 20 is first inserted in housing 10 until it stops at housing shoulder 12. Locking element 30 is preferably assembled through lateral opening 14 of housing 10, through which the locking element is inserted tangentially in annular inner groove 13. Alternatively the locking element can be assembled through the main opening of the housing, similarly to the assembly of the seal. The locking element is orientated so that stop arms 32 are directed with their free ends against the interior of housing 10, i.e. against its connection end. This orientation may, for example, be forced and secured by an asymmetrical design of the locking element and/or of opening 14. Locking element 30 is inserted until its thickened rear end 34 stops against the front edge of opening 14 viewed in the direction of insertion. The front end 33 of locking element 30, which is also slightly thickened, also appears here in opening 14 after passing through inner groove 13, and encloses its rear edge viewed in the direction of insertion. Locking element 30 is arranged and secured fixedly in this manner in inner groove 13, its rear thickened end 34 always being visible and accessible in the “window” of opening 14 without projecting outwards from the housing. In FIG. 2 the rear end lies flush on the outside against the housing. The seal in housing 10 is also secured by locking element 30 because stop arms 32 of the locking element project into the free cross-section of the housing.

With seal 20 and locking element 30 pre-mounted in this manner, the connection device according to the invention is ready for use.

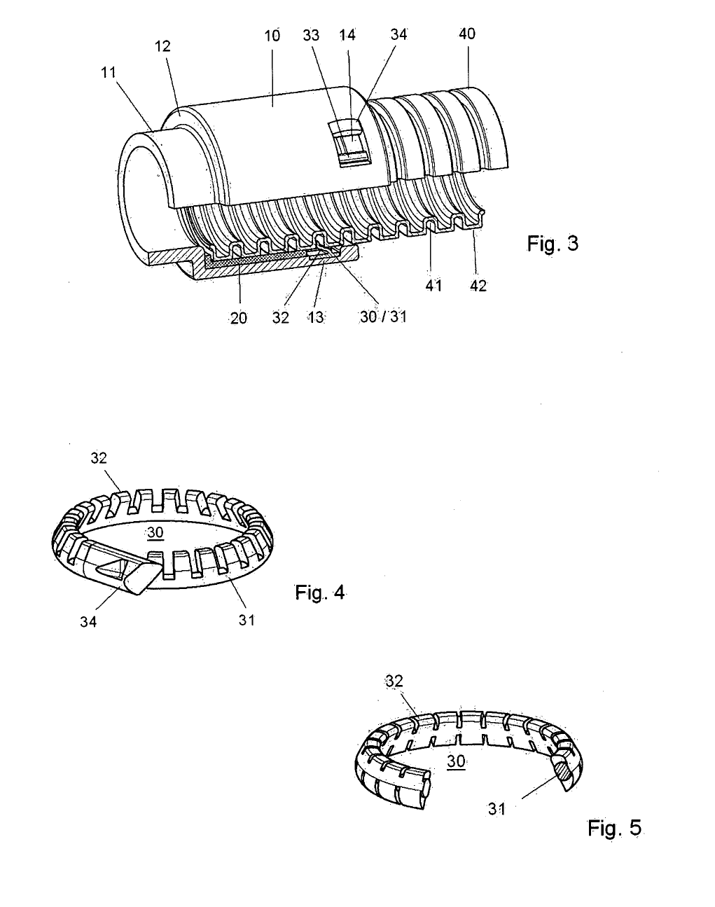

To make a connection to a pipe 40 such as the corrugated pipe shown, it is sufficient to insert the pipe into housing 10 in its longitudinal direction. When the pipe is inserted, stop arms 32 of locking element 30 projecting obliquely inwards are deflected elastically outwards by the corrugation peaks 42 of pipe 40, and engage, after corrugation peaks 42, into corrugation valleys 41 or the annular outer grooves of pipe 40 formed by them. FIG. 3 shows the corresponding situation in which pipe 40, as is preferred, is pushed forward as far as the stop on housing shoulder 12 so that stop arms 32 engage in the fourth corrugation valley or the third outer groove from the front pipe end. Because of the contact of the foremost three corrugation peaks 42 on seal 20, sealing is also provided so that it would be possible to use the device for connecting a fluid line or the like.

When engaged in this manner pipe 40 can no longer be pulled out of the housing. In this case the engagement is self-inhibiting, for stop arms 32 of the locking element would be further straightened under the influence of an extraction force, would penetrate deeper into outer groove 41 of pipe 40, and further reduce the cross-section. A favourable effect is produced here in that the free ends of stop arms 32 are deflected additionally inwards. Because of the tight arrangement of the stop arms and their distribution around practically the entire circumference, the load distribution is also the optimum, so that high extraction forces can be absorbed. The angle of pitch of pipe 40 to or through locking element 30 is approximately 360°, should not be less than 270° and amounts to 340° in the exemplary embodiment shown.

In order to loosen the engagement locking element 30 is pulled out of housing 10 through housing opening 14 in the tangential direction so that it can be gripped with a pointed tool, for example, at its thickened rear end 34 accessible in housing opening 14. For attachment of the tool the thickened rear end 34 may also be provided with a small hole or the like.

FIGS. 4, 5 and 6 show examples of alternative embodiments of locking elements 30 which can also be used within the scope of the invention.

Locking element 30 in FIG. 4 is most similar to locking element 30 described above and, like this element, has a strip-like base element 31 and, formed on, stop arms 32 directed obliquely inwards. Unlike locking element 30 described above, where the strip-like base element 31 does not change its orientation when stop arms 32 are deflected, strip-like base element 31 is here also rotated when stop arms 32 are deflected. Stop arms 32 themselves are almost inflexible relative to base element 31. The entire locking element 30 therefore twists when a pipe is pushed through or under an extraction force.

In the case of locking element 30 in FIG. 5, strip-like base element 31 is arranged in the centre of the stop arms. Here base element 31 may be understood as the axis f rotation of stop arms 32.

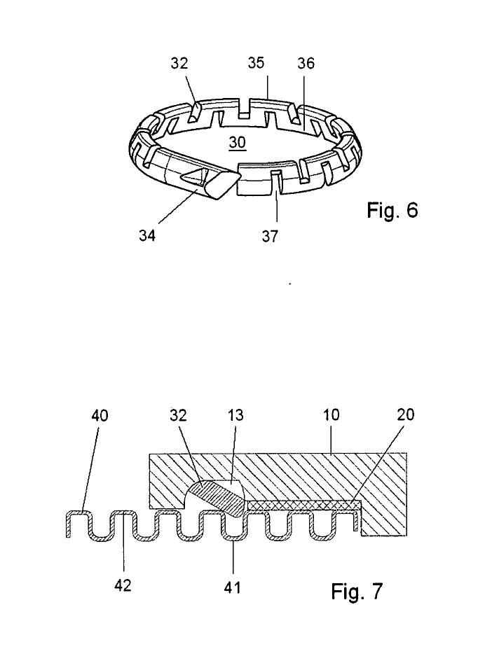

Locking element 30 in FIG. 6 is meander-shaped, so that a distinction can no longer be made here between a base element and stop arms 32. As in the case of locking elements in FIGS. 4 and 5, element 30 is deflected elastically by the intrinsic torsion of the entire element. Embodiment 30 shown in FIG. 6 provides a particularly favourable ratio between the potential force transmission surfaces 35 and 36 for the transmission of the extraction forces and the slotted perforations 37. This gives rise to favourable torsional flexibility for simple assembly, combined with high extraction resistance.

FIG. 7 shows diagrammatically, in a section, how stop arms 32 of element 30 in FIG. 6 are able to engage in an especially favourably shaped inner groove 13 of housing 10 and in an outer groove 41 of a corrugated pipe 40. Here inner groove 13 is provided with a unilaterally rounded cross-section which facilitates the twisting of locking element 30 when corrugated pipe 40 is inserted, thereby releasing the cross-section required for the insertion. On the other hand the cross-section is chosen so that stop arms 32 wedge in groove 41 under the influence of an extraction force. Corresponding cross-sections may be provided for inner groove 13 of housing 10 for the embodiments shown in FIGS. 4 and 5.

Compared to the embodiment of locking element 30 shown in FIG. 1, locking elements 30 shown in FIGS. 4-6 are more robust and are able to resist higher breakout forces. In the embodiment shown in FIG. 1 only stop arms 32 on non-deforming basic element 31 are deflected and must therefore be designed in a rather filigree manner so that the resistance which they oppose to the insertion of the pipe does not become excessive.

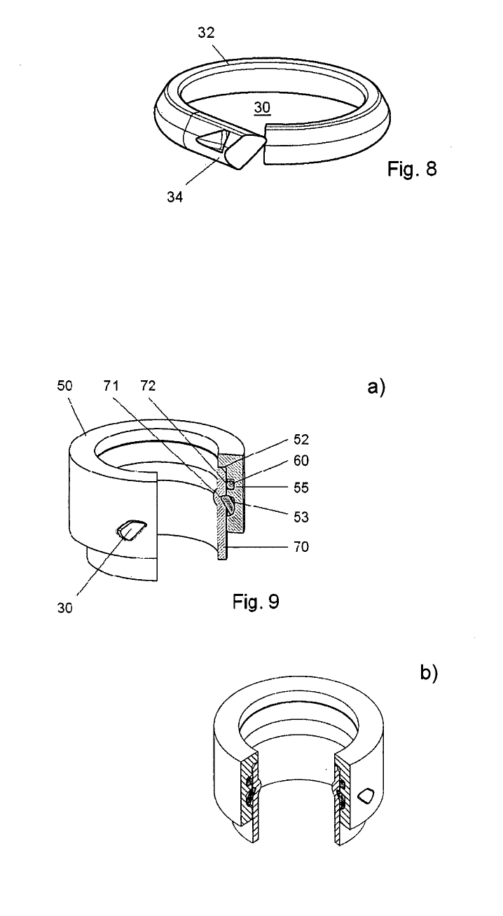

FIG. 8 shows an embodiment of a locking element 30 in which a slotted perforation according to locking element 30 in FIG. 6 is dispensed with. This embodiment is suitable for extremely elastic materials or materials with marked elasticity in the peripheral direction of annular inner groove 13. Such material elasticity enables the integral stop spring to expand or compress in the edge bevel during the torsional movement.

FIG. 9 shows in a) a further embodiment of the connection device according to the invention, with a housing 50, an O ring seal 60 and a meander-shaped locking element 30 in the nature of the locking element shown in FIG. 6 for connecting a pipe 70.

However, the locking element could also be designed in this assembly according to the embodiments shown in FIGS. 1-3, 4, 5 or 8.

Housing 50 is again sleeve-shaped, has a housing shoulder 52, a first annular inner groove 53 for engagement of locking element 30.3, and a second annular inner groove 55 for O ring seal 60. Compared to housing 10 in FIG. 1, housing 50 is shorter in its axial direction because O ring seal 6O requires less space than sleeve-shaped seal 20. A connection end comparable to connection end 11 of housing 10, is not shown in the case of housing 50, but could also be provided.

Locking element 30 shown in FIG. 9 in a) can be removed from housing 10 by being rotated to the left, i.e. anticlockwise. However, the reverse arrangement would also be possible with a shutoff element that can be removed by rotating to the right, i.e. clockwise, as shown in b) in FIG. 9. Where spatial conditions are confined, the direction of rotation in which the locking element can be removed may be significant in certain circumstances. Generally all the embodiments according to the invention can be designed in one way or another in this respect.

Connected pipe 70 shown in FIG. 9 is not, incidentally, a corrugated pipe but is smooth and provided with only one outer groove 71 because of a single constriction. This shows that the invention can be used for connecting many different types of pipes. O ring seal 60 seals against the smooth outer side 72 of the pipe before outer groove 71. In connection with the embodiment shown in FIGS. 1-3 one possibility of arranging locking element 30 fixedly in the pre-mounted position in housing 10 has already been explained. In this embodiment the rotation protection is provided automatically when the locking element is pre-mounted, i.e. no additional measures or operations are required for its production or activation. The rotation protection described may also be easily loosened again by pushing the front thickened end 33 of locking element 30 inwards, thus releasing it from engagement with the rear edge of housing opening 14 viewed in the direction of insertion.

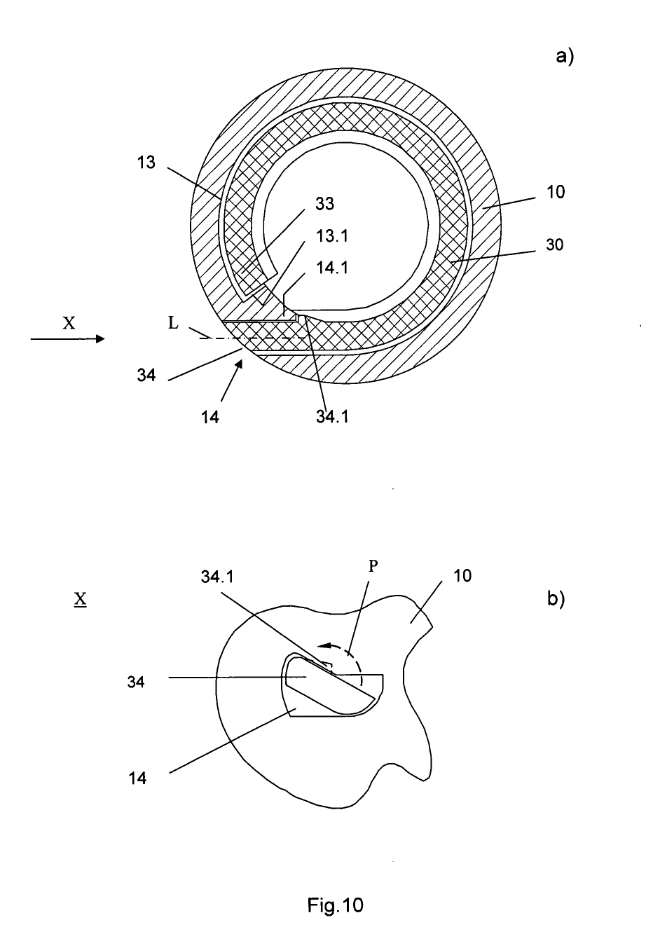

Further embodiments are explained in the following with reference to FIGS. 10-16 for devices preventing the locking element from rotating without additional operations during pre-mounting of the locking element, which devices can easily be loosened. Here the direction of viewing in the sectional drawings of FIGS. 10 a), 11, 13a), 14a) and 15 always corresponds to the direction of insertion of the pipe end in the housing shown.

In the embodiment shown in FIG. 10 locking element 30 has a front 33 and a rear end 34 and a stop nose 34.1 formed in the region of rear end 34 relative to the direction of insertion opposing the direction of extraction. At one end of inner groove 13 housing 10 has a first stop 13.1 and in the region of opening 14 a second stop 14.1. In its pre-mounted position locking element 30 is prevented from rotating in the direction of insertion by stopping with its front end 33 on first stop 13.1, and is prevented from rotating in the direction of extraction by engaging around and behind second stop 14.1 with stop nose 34.1.

As shown in FIG. 10, in b), housing opening 14 is widened relative to the cross-section of locking element 30 or its rear end 34 so that locking element 30 or its rear end can be rotated or twisted against its own elasticity about its longitudinal direction L, so that stop nose 34.1 becomes disengaged from second stop 14.1. Locking element 30 can then be pulled out of housing opening 14. During the pre-assembly of shutoff element 30 stop nose 34.1 automatically engages behind second stop 14.1 under the influence of the elasticity of locking element 30 as soon as locking element 30 is pushed fully into inner groove 13 and stops with its front end against first stop 13.1.

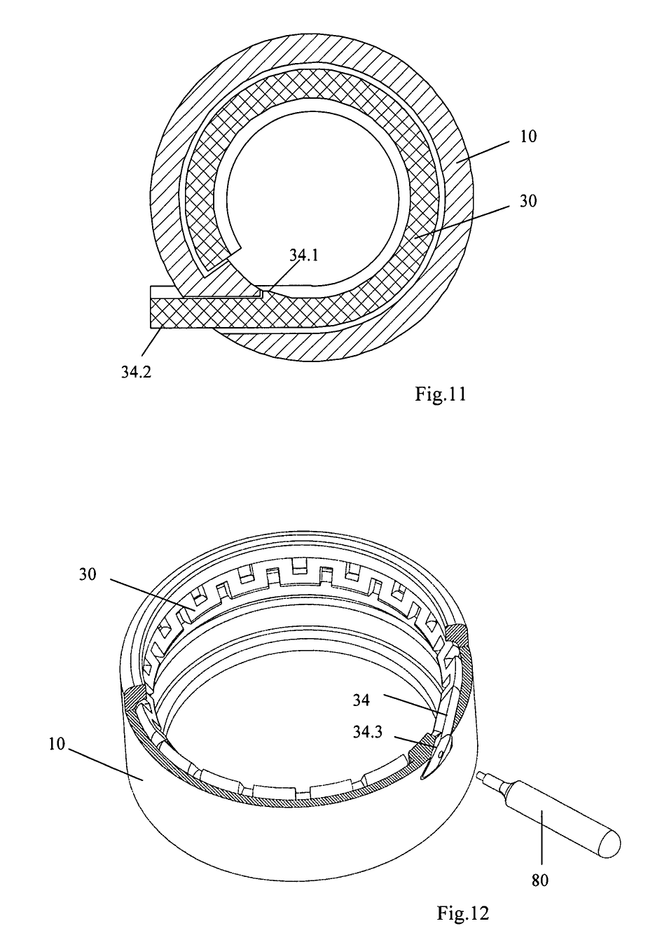

To facilitate the manipulation for loosening the rotation protection of locking element 309 described above, this element, as shown in FIG. 11, may have a short projection 34.2 from housing 10, so that the rotation or torsion of locking element 30 can be carried out directly by hand. Rear end 34 may also be provided with an insert opening 34.3, such as a small hole, for example, for attaching a tool 80, as shown in FIG. 12. In this case it may be possible to countersink locking element 30 completely in housing 10. A combination of both measures shown in FIG. 11 and 1 would of course also be possible.

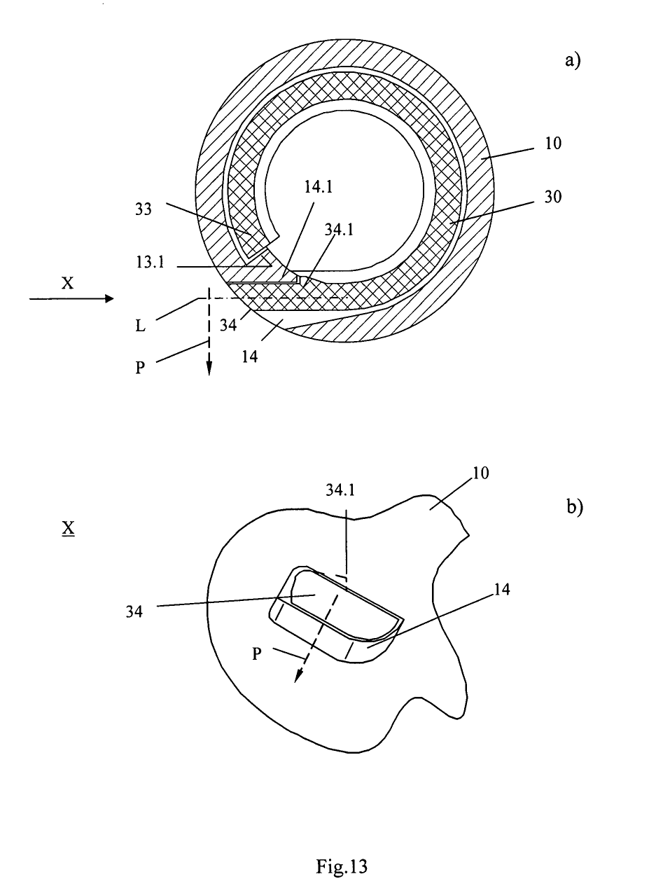

FIG. 13 shows in a) housing 10 of one embodiment of a connection device with locking element fixedly arranged and secured therein, which element, like locking element 30 in FIG. 10, is prevented, by bearing with its front end 33 against a first stop 13.1, from rotating in the direction of insertion, and by enclosing a second stop 14.1 with a stop nose 34.1 from rotating in the direction of extraction.

However, unlike the embodiment shown in FIG. 10, housing opening 14 is here widened relative to the cross-section of locking element 30 or its rear end 34, to the extent that locking element 30 or its rear end 34 can be bent against its own elasticity laterally relative to its longitudinal direction, so that stop nose 34.1 becomes disengaged from second stop 14.1. This method of loosening the rotation protection is illustrated once again diagrammatically in b). In this embodiment use could also be made of the measures shown in FIG. 11 and/or 12.

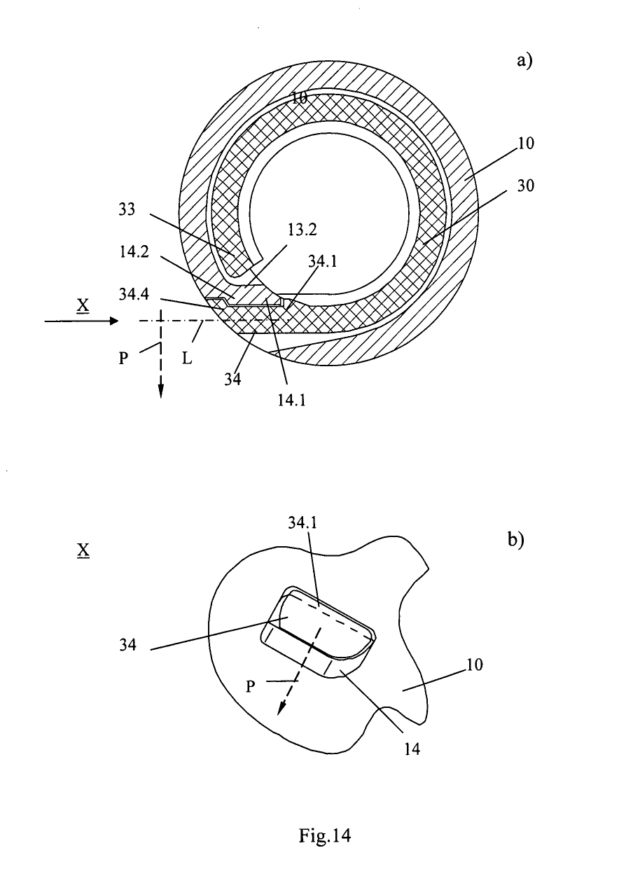

The embodiment shown in FIG. 14 corresponds to the embodiment in FIG. 13 in terms of the loosening mechanism of locking element 30. What is designed differently here, however, is the type of protection of locking element 30 against rotation in the direction of insertion. Instead of bearing with its front end 33 in the direction of insertion against a stop at the end of inner groove 13, locking element 30 is provided in the region of its rear end 34 with a further stop nose 34.3 and housing 10 is provided in the region of opening 14 with a further stop 14.2. In its pre-mounted position the locking element is prevented from rotating in the direction of insertion by bearing with further stop nose 34.4 against further stop 14.2. Here front end 33 of the locking element is preferably located at a certain distance from end 13.2 of inner groove 13. This design has the advantage of more accurate positioning of locking element 30, which is no longer determined by its longitudinal tolerance.

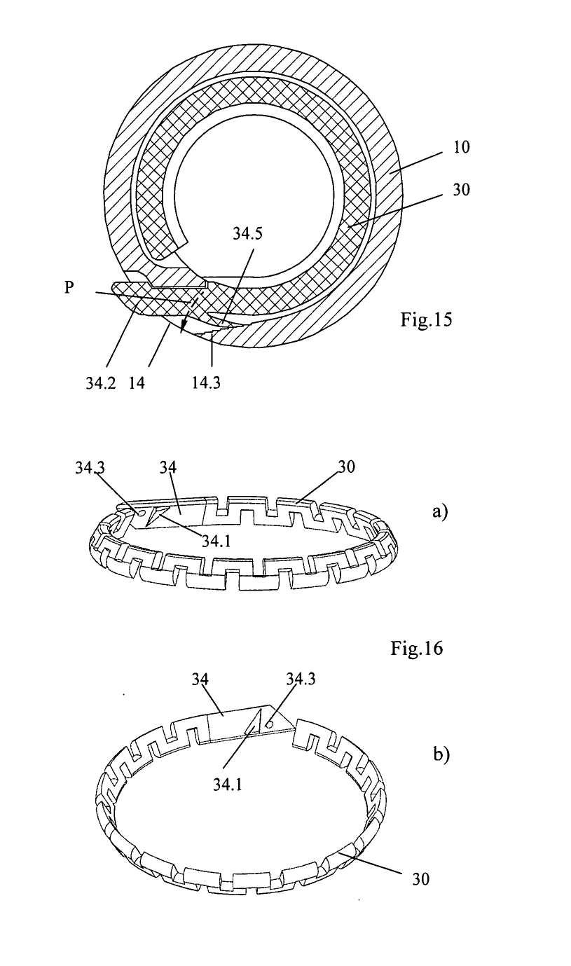

The embodiment shown in FIG. 15 corresponds to that shown in FIG. 14, but here an auxiliary device is additionally provided for moving locking element 30 out of housing 10. This operates in the manner of a ratchet, for which purpose a spring arm 34.5 is provided on rear end 34 of locking element 30 and projects from it, and a multi-stepped stop surface 14.3 is provided on housing opening 14. Spring arm 34. 5 engages with stop surface 14.3 in the manner of a paw. The auxiliary device is actuated by pressing, for example with the finger, on projection 34.2, spring arm 34.5 being bent towards locking element 30 and pressing it a short distance outwards. When the projection is released the spring arm jumps outwards by one step on stop surface 14.3, whereupon the process described can be repeated several times if necessary.

FIG. 16 shows, in a) and b), perspective representations of a meander-shaped locking element 30, with stop nose 34.1 and insertion opening 34.3 for a tool, e.g. corresponding to tool 80.

Locking element 30 could also be secured in the housing with a sticker covering housing opening 14. The sticker could in this case be reusable in nature or could perform the function of a seal. For easier removal the sticker could be provided with an adhesive-free gripping edge.

The invention is not limited either to its application merely as a locking element. A plurality locking elements could also be arranged behind one another, thereby increasing the breakout strength.

Similarly (or also in combination with a plurality of locking elements) a plurality of seals, in particular O ring seals or cord seals in a different design, could also be arranged behind one another to reinforce the sealing action. The cross ring seal is mentioned here as an example of alternative forms of cord seals.

All the component parts of the connection device according to the invention may be produced from polymer materials, preferably based on polyamides, by injection moulding. For producing locking elements of the type shown in FIG. 1 the material should not be too stiff, to ensure that the stop arms have sufficient flexibility and do not break under load. For polyamide 6, for example, with a tensile breaking elongation of >50%, this condition would be met. For producing locking elements shown in FIGS. 4-6, however, a much stiffer HT polyamide (=partially aromatic, partially crystalline polyamide with a higher melting point) with a tensile breaking elongation of <5% could also be used because these elements only shrink internally, and generally to a lesser extent.

The connection device according to the invention, described above, is preferably used in the field of corrugated protective cable conduits for the fields of mechanical engineering, robotics and rail vehicles, and also in the field of media-conducting pipes (fluid pipes ) in industry and the motor manufacture.

### LIST OF REFERENCE NUMBERS

10 Housing
11 Connection end of the housing
12 Housing shoulder
13 Annular inner groove in the housing
13.1 First stop
13.2 End of inner groove 13
14 Opening for the annular groove in the housing
14.1 Second stop
14.2 Further stop
14.3 Stop surface
20 Sleeve-shaped seal
30 Locking element
31 Strip-shaped base element
32 Stop arms
33 Front end
34 Rear end
34.1 Stop nose on rear end 34
34.2 Projection
34.3 Insertion opening
34.4 Further stop nose
34.5 Spring arm
40 Corrugated pipe
41 Corrugation valleys of the corrugated pipe/annular outer groove
42 Corrugation peaks of the corrugated pipe
50 Housing
52 Housing shoulder
53 First annular inner groove in the housing
55 Second annular inner groove in the housing
60 O ring seal
70 Pipe
71 Annular groove in the pipe
72 Sealing surface on the pipe
80 Tool

1. A connection device for a pipe with annular outer groove, which has a housing in which the pipe can be inserted and locked therein by means of a locking element, wherein the locking element engages in an annular inner groove of the housing and in the annular outer groove of the pipe, and can be pulled out of the housing through an opening in the housing in a direction tangential to the annular grooves, and wherein the locking element is pre-mountable in the inner groove of the housing, enables the pipe to be inserted in the housing in this position with elastic deflection and to engage here in the outer groove of the pipe, and in doing so engaging in the outer groove of the pipe, wherein the locking element is arranged and secured fixedly in the housing in this position by bearing against an edge and by enclosing an edge.

2. The connection device according to claim 1, wherein the angle of pitch of the pipe to the locking element is at least 270°.

3. The connection device according to claims 1 or 2, wherein the locking element twists into itself and/or is provided with elastically flexible stop arms.

4. The connection device according to claim 3 wherein the stop arms are formed on a strip-shaped base element at an oblique angle.

5. The connection device according to claim 3, wherein in that the locking element is meander-shaped.

6. The connection device according to claim 3, wherein the locking element has a uniform cross-section at least along the region of the engagement.

7. The connection device according to claim 1, wherein the locking element can be countersunk completely in the housing.

8. The connection device according to claim 7, wherein the locking element has a thickened end with which it bears in its pre-mounted position against an edge of the housing opening.

9. The connection device according to claim 8, wherein the locking element has a front and a rear thickened end viewed in the direction of insertion oppose to the direction of extraction, in that the housing opening has a front and a rear edge viewed in the direction of insertion, and in that the locking element, in it pre-mounted position, is arranged and secured fixedly in the housing by bearing with its rear thickened end against the front edge of the housing opening, and by enclosing the rear edge of the housing opening with its front thickened end.

10. The connection device according to claim 9, characterised in that wherein the locking element has a front and rear end viewed in the insertion direction opposite the direction of extraction and a stop nose formed in the region of the rear end, in that the housing has a first stop at one end of the inner groove and a second stop in the region of the opening, and in that the locking element, in its pre-mounted position, is prevented from rotating in the direction of insertion by bearing with its front end against the first stop, and from rotating in the direction of extraction by engaging around and behind the second stop with the stop nose.

11. The connection device according to claim 8, wherein the locking element has a front and rear end viewed in the direction of insertion opposite the direction of extraction and a stop nose formed in the region of the rear end as well as a further stop nose, in that the housing has an inner second and an outer third stop in the region of the opening, and in that the locking element, in its pre-mounted position, is prevented from rotating in the direction of insertion by bearing with its further stop nose against an outer third stop, and from rotating in the direction of extraction by engaging around or behind the second stop with its front stop nose.

12. The connection device according to claim 11, wherein the front end of the locking element, in its pre-mounted position, is positioned at a certain distance from one end of the inner groove.

13. The connection device according to claim 12, wherein the protection of the locking element in its pre-mounted position against rotating in the direction of extraction can be loosened by a torsion of its rear end.

14. The connection device according to claim 12, wherein the protection of the locking element in its pre-mounted position against rotation in the direction of extraction can be loosened by lateral bending of its rear end.

15. The connection device according to claim 13, wherein the locking element is provided, in the region of its rear end, with an insertion opening for a tool for loosening the protection of the locking element, in its pre-mounted position, against rotation in the direction of extraction.

16. The connection device according to claim 15, wherein the locking element, in its pre-mounted position, has a projection from the housing that can be used as a handle for loosening the protection of the locking element, in its pre-mounted position, against rotation in the direction of extraction.

17. The connection device according to claim 14, wherein it is provided with an auxiliary device for moving the locking element out of the housing in the form of a ratchet actuated by the lateral bending of the rear end of the locking element with a spring arm and a multi-stepped stop surface.

18. The connection device according to claim 17, wherein the inner groove is provided with a rounded profile.

19. The connection device according to claim 18, wherein it is provided with a seal, in particular a sleeve-shaped flat seal or an O ring seal.

20. The connection device according to claim 19, wherein the seal is arranged in the direction of insertion of the pipe on the other side of the locking element.

21. The connection device according to claim 20, wherein a plurality of locking elements are arranged one behind the other.

22. The connection device according to claim 21, wherein a plurality of seals are arranged one behind the other.

23. The connection device according to claim 22, wherein its parts are produced from polymer materials.

24. Use of the connection device according to claim 23 is in the field of corrugated cable protection conduits for the areas of mechanical engineering, robotics or rail vehicles.

25. Use of the connection device according to claim 23 is in the field of media-conducting pipes in industry or motor manufacture.
